(19) United States
(12) Patent Application Publication
(10) Pub. No.: US 2020/0001651 A1
(43) Pub. Date: Jan. 2, 2020

(54) Pneumatic Tire

(71) Applicant: The Yokohama Rubber Co., LTD., Minato-ku, Tokyo (JP)

(72) Inventors: Ryutaro Nakagawa, Hiratsuka-shi, Kanagawa (JP); Hiroki Sugiura, Hiratsuka-shi, Kanagawa (JP)

(21) Appl. No.: 16/482,566

(22) PCT Filed: Jan. 31, 2018
(86) PCT No.: PCT/JP2018/003214

§ 371 Date: Jul. 31, 2019

(30) Foreign Application Priority Data
Feb. 3, 2017 (JP) 2017-018266
Oct. 4, 2017 (JP) PCT/JP2017/036116

(51) Int. Cl. B60C 11/00; C08L 7/00; B60C 1/00

(52) U.S. Cl. CPC B60C 11/0008; C08L 7/00; C08L 2205/06; B60C 11/0075; C08L 2205/03; B60C 1/0016

(57) ABSTRACT

Provided is a pneumatic tire. An undertread is obtained by blending Wu parts by mass (Wu≥0) of a softener (U) including a plasticizer component with 100 parts by mass of a rubber component. A cap tread is obtained by blending 30 parts by mass or greater of silica and Wc parts by mass (Wc is from 20 to 70) of a softener (C) including from 5 to 30 parts by mass of a resin component having a softening point of from 90° C. to 150° C. and a plasticizer component with 100 parts by mass of a diene rubber containing 30 mass % or greater of polybutadiene. The cap tread rubber component has a mass ratio of the resin component in the softener of from 0.1 to 0.5. A difference (Wc−Wu) in compounded amount between the softener and the softener is from 20 parts by mass to 60 parts by mass.

### TECHNICAL FIELD

The present technology relates to a pneumatic tire that suppresses a change in physical properties over time and maintains superior performance on ice.

### BACKGROUND ART

In a pneumatic tire for winter, a tread rubber contains a large amount of oil component, and thus performance on ice may be improved. It is required that initial performance on ice is superior and the performance on ice is maintained for several years. However, the performance on ice may be reduced when the oil component in the tread rubber flows to the outside or migrates to a member adjacent to the tread rubber during use or storage from spring to fall.

Japan Unexamined Patent Publication No. H05-262103 describes that the softener concentration in an undertread portion is higher than the softener concentration in a cap tread portion, and thus the initial rubber hardness and performance on ice of the cap tread portion are maintained. However, due to the softener concentration of the undertread portion that is higher than that of the cap tread portion, steering stability is deteriorated. In recent years, development of a pneumatic tire having higher performance is required. A pneumatic tire that provides more superior performance on ice while suppressing a change in physical properties over time is required.

### SUMMARY

The present technology provides a pneumatic tire that suppresses a change in physical properties over time and maintains superior performance on ice.

A pneumatic tire according to an embodiment of the present technology includes a tread portion having a cap tread disposed outward in a tire radial direction and an undertread disposed inward in the tire radial direction. The undertread is made of a rubber component for an undertread obtained by blending Wu parts by mass (provided that Wu means a real number of 0 or greater) of a softener U including a plasticizer component with 100 parts by mass of a rubber component. The cap tread is made of a rubber component for a cap tread that is obtained by blending 30 parts by mass or greater of silica and Wc parts by mass (provided that Wc means a real number of from 20 to 70) of a softener C including from 5 to 30 parts by mass of at least one resin component having a softening point of from 90° C. to 150° C. and a plasticizer component with 100 parts by mass of a diene rubber containing 30 mass % or greater of polybutadiene, and has a mass ratio of the resin component in the softener C of from 0.1 to 0.5 and a rubber hardness at 20° C. with type A in accordance with JIS (Japanese Industrial Standard) K6253 of 60 or less. A difference (Wc−Wu) in compounded amount between the softener C and the softener U is from 20 parts by mass to 60 parts by mass.

In a pneumatic tire according to an embodiment of the present technology, an undertread includes Wu parts by mass of a softener U including a plasticizer component, a cap tread includes Wc parts by mass of a softener C including a specific resin component and a plasticizer component, a difference (Wc−Wu) in compounded amount between the softener C and the softener U is from 20 parts by mass to 60 parts by mass, the mass ratio of the resin component in the softener C is from 0.1 to 0.5, and the rubber hardness of a rubber composition for a cap tread at 20° C. with type A in accordance with JIS K6253 is 60 or less. Thus, migration of the softener from the cap tread to the undertread is reduced as far as possible. Accordingly, the rubber hardness over time can be suppressed and superior performance on ice can be maintained beyond levels in the related arts.

In the pneumatic tire according to an embodiment of the present technology, the ratio (Wc/Wu) of the compounded amount of the softener C to that of the softener U can be from 1.05 to 4.0. The resin component describe above is preferably a terpene resin, and further preferably an aromatic modified terpene resin.

### BRIEF DESCRIPTION OF DRAWINGS

FIG. 1 is a partial cross-sectional view illustrating an example of a pneumatic tire according to an embodiment in a tire meridian direction.

### DETAILED DESCRIPTION

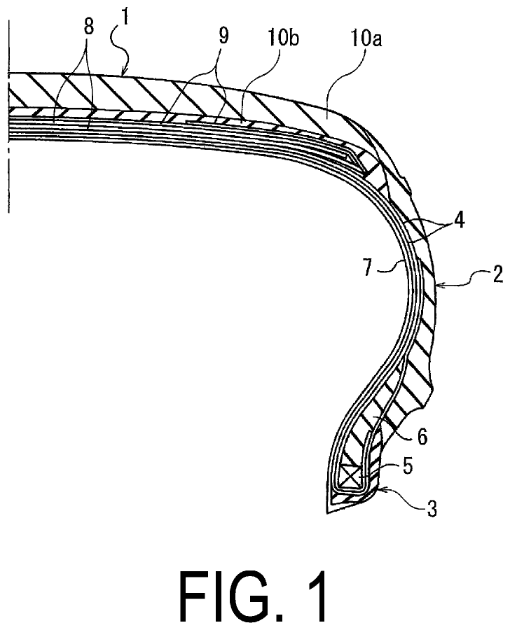

FIG. 1 is a cross-sectional view illustrating an example of a pneumatic tire according to an embodiment. The pneumatic tire includes a tread portion 1, a sidewall portion 2, and a bead portion 3.

In FIG. 1, two carcass layers 4 in which reinforcing cords extending in a tire radial direction are disposed at a predetermined distance in a tire circumferential direction and are embedded in a rubber layer extend between left and right side bead portions 3, and both ends of the two carcass layers 4 are folded back from the inside to the outside in a tire axial direction around a bead core 5 that is embedded in each of the bead portions 3 so that a bead filler 6 is wrapped. An innerliner layer 7 is disposed inward of the carcass layers 4. Two belt layers 8 in which reinforcing cords extending at an incline with respect to the tire circumferential direction are disposed at a predetermined distance in the tire axial direction and are embedded in the rubber layer are disposed on the outer circumferential side of the carcass layers 4 of the tread portion 1. The reinforcing cords of the two belt layers 8 are disposed in a criss-cross manner with opposite inclination directions with respect to the tire circumferential direction. A belt cover layer 9 is disposed outward of the belt layers 8. The tread portion 1 is disposed outward of the belt cover layer 9, and includes a cap tread 10a and an undertread 10b.

The pneumatic tire according to an embodiment of the present technology includes the tread portion, and the tread portion includes the cap tread 10a disposed outward in the tire radial direction, and the undertread 10b disposed inward of the cap tread 10a in the radial direction. The cap tread 10a is made of a rubber composition for a cap tread, and the undertread 10b is made of a rubber composition for an undertread. When the properties of the rubber composition for a cap tread and the rubber composition for an undertread in the pneumatic tire according to an embodiment of the present technology are specified, the rubber hardness over time can be suppressed and superior performance on ice can be maintained beyond levels in the related art.

The rubber composition for a cap tread is obtained by blending a softener C including 30 parts by mass or greater of silica, from 5 to 30 parts by mass of at least one resin component, and a plasticizer component with 100 parts by mass of diene rubber containing 30 mass % or greater of polybutadiene.

The diene rubber that forms the rubber composition for a cap tread necessarily contains polybutadiene. The polybutadiene is contained, and thus rubber hardness at low temperatures can be reduced and performance on ice can be improved. The polybutadiene is contained in an amount of 30 mass % or greater relative to 100 mass % of the diene rubber. When the content of the polybutadiene is less than 30 mass %, the rubber hardness at low temperatures cannot be reduced, and performance on ice cannot be made superior. The content of the polybutadiene is preferably 35 mass % or greater, more preferably greater than 40 mass %, and further preferably 42 mass % or greater. The content of the polybutadiene is preferably 75 mass % or less, more preferably less than 65 mass %, and further preferably 58 mass % or less.

The rubber composition for a cap tread can contain a diene rubber other than polybutadiene. Examples of the other diene rubber include a natural rubber, an isoprene rubber, a styrene-butadiene rubber, an acrylonitrile-butadiene rubber, a butyl rubber, and a halogenated butyl rubber. Of these, a natural rubber, an isoprene rubber, and a styrene-butadiene rubber are preferable. The other diene rubbers may be used alone or as any blend thereof. The content of the other diene rubber is preferably 70 mass % or less, more preferably 65 mass % or less, further preferably less than 60 mass %, and even more preferably 58 mass % or less, relative to 100 mass % of the diene rubber. The content of the other diene rubber is preferably 25 mass % or greater, more preferably greater than 35 mass %, and further preferably 42 mass % or greater.

The rubber composition for a cap tread in an amount of 30 parts by mass or greater, and preferably from 35 to 100 parts by mass is blended with 100 parts by mass of the diene rubber described above. When 30 parts by mass or greater of the silica is blended, performance on ice and wet performance can be improved.

The nitrogen adsorption specific surface area (N₂SA) of the silica is not particularly limited, and is preferably from 100 to 300 m²/g, and more preferably from 120 to 250 m²/g. When the N₂SA of the silica is less than 100 m²/g, wet performance may not be improved. When the N₂SA of the silica is greater than 300 m²/g, workability may be deteriorated. In the present specification, the N₂SA of the silica is measured in accordance with JIS K6217-2.

In an embodiment of the present technology, a silane coupling agent is preferably blended together with the silica. The silane coupling agent is blended, and thus the dispersibility of silica in the diene rubber can be improved, and an effect that improves performance on ice and wet performance can be enhanced.

The type of the silane coupling agent is not particularly limited as long as it is a silane coupling agent that can be used for a rubber composition for a tire. Examples thereof include sulfur-containing silane coupling agents such as bis(3-triethoxysilylpropyl)tetrasulfide, bis(3-triethoxysilylpropyl)disulfide, 3-trimethoxysilylpropyl benzothiazole tetrasulfide, γ-mercaptopropyl triethoxysilane, and 3-octanoylthiopropyl triethoxysilane.

The compounded amount of the silane coupling agent is preferably from 3 to 15 mass %, and more preferably from 5 to 10 mass %, relative to the mass of the silica. When the compounded amount of the silane coupling agent is less than 3 mass % of the compounded amount of the silica, the dispersibility of the silica may not be sufficiently improved. When the compounded amount of the silane coupling agent is greater than 15 mass % of the compounded amount of the silica, the silane coupling agent is condensed, and desired hardness and strength of the rubber composition cannot be achieved.

In an embodiment of the present technology, an inorganic filler other than silica may be blended. Examples of the inorganic filler include carbon black, clay, talc, mica, and calcium carbonate. Of these, carbon black is preferable since rubber strength, wear resistance, and the like can be enhanced.

The rubber composition for a cap tread contains the softener C. The softener C is made of a resin component and a plasticizer component. The compounded amount of the softener C is from 20 parts by mass to 70 parts by mass, and preferably from 25 to 50 parts by mass, relative to 100 parts by mass of the diene rubber. In the present specification, the compounded amount of the softener C is Wc parts by mass. When the compounded amount Wc of the softener C is less than 20 parts by mass, performance on ice is deteriorated. When the compounded amount Wc of the softener C is greater than 70 parts by mass, the amount of softener that migrates from the cap tread to the undertread is increased.

The resin component is a thermoplastic resin having a softening point of from 90° C. to 150° C. When the softening point of the resin component is lower than 90° C., the softener tends to migrate from the cap tread to the undertread. When the softening point of the resin component is higher than 150° C., processability and performance on ice are deteriorated. In the present specification, the softening point of a resin is measured in accordance with JIS K6220-1 (ring and ball method).

Examples of the resin component include hydrocarbon resins including aromatic hydrocarbon resins such as a styrene-a-methylstyrene resin, an indene-isopropenyl toluene resin, and a coumarone-indene resin, a dicyclopentadiene resin, and a petroleum resin in which a main raw material is 1,3-pentadiene, pentene, or methylbutene, an alkylphenolic resin, a modified phenolic resin, a terpene phenolic resin, a terpene resin, and an aromatic modified terpene resin. Preferable examples thereof include a terpene resin, a rosin resin, and an olefinic resin. Of these, one type of the resin composition can be blended or a plurality of types of the resin compositions can be blended in combination.

Examples of the terpene resin include a terpene resin, a terpene phenolic resin, and an aromatic modified terpene resin. Of these, an aromatic modified terpene resin is preferable. The aromatic modified terpene resin is preferably an aromatic modified terpene resin obtained by polymerizing a terpene such as α-pinene, β-pinene, dipentene, or limonene, and at least one aromatic compound of styrene, α-methylstyrene, or vinyl toluene.

In the rubber composition for a cap tread, the resin component is blended in an amount of from 5 to 30 parts by mass, and preferably from 7 to 25 parts by mass, relative to 100 parts by mass of the diene rubber. When the compounded amount of the resin component is less than 5 parts by mass, the effect of reducing the amount of the softener that migrates from the cap tread to the undertread cannot be sufficiently obtained. When the compounded amount of the resin component is greater than 30 parts by mass, performance on ice is reduced.

The mass ratio of the resin component in the softener C is from 0.1 to 0.5, and preferably from 0.15 to 0.4. Herein, the mass ratio of the resin component in the softener C refers to the mass ratio of the compounded amount of the resin component to the sum of the compounded amount of the resin component and the compounded amount of the plasticizer component. When the mass ratio of the resin component is less than 0.1, the effect of reducing the amount of the softener that migrates from the cap tread to the undertread cannot be sufficiently obtained. When the mass ratio of the resin component is greater than 0.5, performance on ice is reduced.

The rubber composition for a cap tread according to an embodiment of the present technology contains the plasticizer component. Examples of the plasticizer component include processing oils such as a paraffinic processing oil, an aromatic processing oil, and a naphthenic processing oil, an aroma oil, a vegetable oil, a liquid rubber, a petroleum-based plasticizer, a coal tar plasticizer, and a fatty oil-based plasticizer. When the diene rubber is an oil-extended rubber and contains an oil component, the plasticizer component contains an oil-extending component of the oil-extended rubber. In the present specification, a wax is not included in the plasticizer component.

The compounded amount of the plasticizer component in the rubber composition for a cap tread can be determined from a difference between the compounded amount of the softener C that is We parts by mass and the compounded amount of the resin component. At the same time, the compounded amount of the plasticizer component is determined so that the mass ratio of the compounded amount of the resin component to the sum of the compounded amount of the plasticizer component and the compounded amount of the resin component falls within the range of the mass ratio described above.

The rubber hardness of the rubber composition for a cap tread at 20° C. with type A in accordance with JIS K 6253 is 60 or less. When the rubber hardness is greater than 60, the flexibility of rubber at low temperatures is insufficient, and performance on ice is reduced. The rubber hardness of the rubber composition for a cap tread is preferably from 40 to 58, and more preferably from 45 to 55. In the present specification, the rubber hardness of the rubber composition refers to the hardness of the rubber measured at a temperature of 20° C. with a type A durometer in accordance with JIS K6253.

In an embodiment of the present technology, the rubber composition for an undertread is obtained by blending Wu parts by mass of a softener U containing a plasticizer component with 100 parts by mass of the rubber component. Wu means a real number of 0 or greater. The rubber component that forms the rubber composition for an undertread includes a natural rubber, an isoprene rubber, a butadiene rubber, and a styrene-butadiene rubber, and preferably include a natural rubber, a butadiene rubber, and a styrene-butadiene rubber. The plasticizer component can be appropriately selected from the same group as the group of the plasticizer component contained in the rubber composition for a cap tread described above. The plasticizer component is a component except for a wax. The plasticizer component of the rubber composition for an undertread may be the same as or different from the plasticizer component contained in the rubber composition for a cap tread. The plasticizer component may be blended alone or a plurality of types thereof may be blended in combination. The rubber composition for an undertread preferably contain no resin component.

In the rubber composition for an undertread, the compounded amount (Wu parts by mass) of the softener U is 0 part by mass or greater. The compounded amount of the softener U is determined so that the difference (Wc−Wu) between the compounded amount (Wc parts by mass) of the softener C and the compounded amount (Wu parts by mass) of the softener U in the rubber composition for a cap tread ranges from 20 parts by mass to 60 parts by mass. When the difference (Wc−Wu) in compounded amount is less than 20 parts by mass, the effect of reducing the amount of the softener that migrates from the cap tread to the undertread cannot be sufficiently obtained. The difference (Wc−Wu) in compounded amount is preferably 22 parts by mass or greater, more preferably 23 parts by mass or greater, and further preferably 23 parts by mass or greater. When the difference (Wc−Wu) in compounded amount is greater than 60 parts by mass, the softener tends to migrate from the cap tread to the undertread. The difference (Wc−Wu) in compounded amount is preferably 58 parts by mass or less, more preferably 55 parts by mass or less, further preferably 48 parts by mass or less, and even more preferably 37 parts by mass or less.

In an embodiment of the present technology, the ratio (Wc/Wu) of the compounded amount (Wc parts by mass) of the softener C in the rubber composition for a cap tread to the compounded amount (Wu parts by mass) of the softener U in the rubber composition for an undertread is not particularly limited, and is preferably from 2.0 to 40.0, more preferably from 2.0 to 10.0, further preferably from 2.5 to 7.0, and even more preferably from 3.0 to 5.0. When the ratio (Wc/Wu) of the compounded amounts of the softeners is less than 2.0, the effect of reducing the amount of the softener that migrates from the cap tread to the undertread may not be sufficiently obtained. When the ratio (Wc/Wu) of the compounded amount is greater than 40.0, the softener may tend to migrate from the cap tread to the undertread.

In the rubber composition for an undertread, the rubber composition can contain an inorganic filler such as carbon black and silica, a silane coupling agent, and the like, in addition to the softener U formed of the plasticizer component. The same or different types of inorganic filler and silane coupling agent that are blended in the rubber composition for a cap tread can be selected, and can be each blended in an appropriate amount.

The rubber hardness of the rubber composition for an undertread at 20° C. with type A in accordance with JIS K 6253 is not particularly limited, and is preferably from 45 to 75, and more preferably from 50 to 70. When the rubber hardness of the rubber composition for an undertread is less than 45, steering stability may be deteriorated. When the rubber hardness of the rubber composition for an undertread is greater than 70, performance on ice may be deteriorated. The rubber hardness as of a rubber composition refers to the rubber hardness of a rubber measured at a temperature of 20° C. with a type A durometer in accordance JIS K6253.

In the rubber composition for a cap tread and the rubber composition for an undertread, various additives that are commonly used for pneumatic tire for a tire, such as a vulcanization/crosslinking agent, a vulcanization accelerator, an anti-aging agent, and a peptizing agent can be blended without impairing the configuration of an embodiment of the present technology. These additives may be kneaded by a general method to form a pneumatic tire, and may be used in vulcanization or crosslinking. The rubber composition for a pneumatic tire according to an embodiment of the present technology can be produced by mixing the components described above using a typical kneader for a rubber, such as a Banbury mixer, a kneader, and a roller.

In the pneumatic tire according to an embodiment of the present technology, migration of the softener from the cap tread to the undertread is reduced as much as possible. Thus, rubber curing over time can be suppressed and superior performance on ice can be maintained beyond levels in the related art.

Embodiments according to the present technology are further described below by Examples. However, the scope of the present technology is not limited to these Examples.

### Examples

A cap tread was formed of each of 21 types of rubber compositions for a cap tread (Examples 1 to 14, Standard Example, and Comparative Examples 1 to 6) that was obtained by composition shown in Tables 1 to 3 in a common composition listed in Table 4, and an undertread was formed of each of 3 types of rubber compositions for an undertread (UT compositions 1 to 3) listed in Table 5, to produce a pneumatic tire (size: 195/65R15). In preparation of each of the rubber compositions, components except for a sulfur and a vulcanization accelerator were weighed and kneaded using a 1.7-L internal Banbury mixer for 5 minutes, and the master batch was then discharged and cooled at room temperature. The master batch was placed in the 1.7-L internal Banbury mixer, and a sulfur and a vulcanization accelerator were then placed and mixed to obtain each of the rubber compositions. Table 4 indicates the compounded amounts (part by mass) of compounding agents that are each based on 100 parts by mass of diene rubber indicated in Tables 1 to 3. In Tables 1 to 3, a value in parentheses in a column of “Softener C (Wc)” represents the total compounded amount of the resin component and the plasticizer component (oil) in the rubber composition for a cap tread, and a value in a column of “resin component/softener C” represents the mass ratio of the resin component in the softener C (the total compounded amount of the resin component and the plasticizer component). “Type of rubber composition for undertread” represents a rubber composition for an undertread that has been used among UT compositions 1 to 3 listed in Table 5. A value in parentheses in a column of “Softener U (Wu) of UT” represents the compounded amount Wu of the softener U in the UT compositions 1 to 3. A value in parentheses in a column of “Difference (Wc−Wu) in compounded amount” represents a difference (Wc−Wu) between the compounded amount Wc of the softener C in the rubber composition for a cap tread and the compounded amount Wu of the softener U in the rubber composition for an undertread. A value in parentheses in a column of “Ratio (Wc/Wu) of compounded amounts” represents a ratio (Wc/Wu) of the compounded amount Wc of the softener C in the rubber composition for a cap tread to the compounded amount Wu of the softener U in the rubber composition for an undertread.

The rubber composition for a cap tread was vulcanized in a mold having a given shape at 170° C. for 10 minutes to produce a test piece. The rubber hardness of the test piece was measured by a method described below. The amount of the softener that migrated from the cap tread to the undertread and performance on ice were evaluated by the method described below using the pneumatic tire produced as described above.

### Rubber Hardness

The rubber hardness of the obtained test piece was measured at a temperature of 20° C. with a type A durometer in accordance with JIS K6253. The obtained results are described in a column of “Rubber hardness” of Tables 1 to 3. Smaller rubber hardness achieves flexibility at low temperatures, and is advantageous for performance on ice.

Amount of Softener Migrating from Cap Tread to Undertread

From the obtained pneumatic tire, a small piece of the undertread immediately after vulcanization and molding was cut, and the amount of the softener was measured by measurement using extraction with acetone. The pneumatic tire immediately after vulcanization and molding was heated at 70° C. for 4 weeks, a small piece of the undertread was cut out, and the amount of the softener was measured by measurement using extraction with acetone. The amount of the softener migrating from the cap tread to the undertread was measured from a change in extraction amount after 4 weeks. The obtained results are expressed as index values with Standard Example being assigned 100, and described in a column of “Amount of softener migrating to UT” in Tables 1 to 3. Smaller index values of amount of softener migrating to UT indicate a small amount of the softener migrating from the cap tread to the undertread. This means that a change in characteristics of the pneumatic tire over time is small.

### Performance on Ice

The pneumatic tire (size 195/65R15) obtained was mounted on a standard rim, and adjusted to an air pressure of 170 kPa. This pneumatic tire was mounted on a domestic test vehicle, and a distance from a position where the vehicle was subjected to a braking test after running on a test course including an ice road (road surface temperature: −4° C.) at a constant speed of 40 km/h to a position where the vehicle was stopped was measured 10 times. The obtained results are expressed as index values obtained by calculating a reciprocal of average value of each tire, with Standard Example being assigned the value of 100, and described in a column of “Performance on ice” in Tables 1 to 3. Larger index values of performance on ice indicate a shorter braking distance and superior performance on ice.

TABLE 1

| | | Standard | Comparative | Comparative | |
|---|---|---|---|---|---|
| | | Example | Example 1 | Example 2 | Example 1 |
| NR | Part by | 55 | 55 | 55 | 55 |
| | mass | | | | |
| BR | Part by | 45 | 45 | 45 | 45 |
| | mass | | | | |
| Carbon black | Part by | 15 | 15 | 15 | 15 |
| | mass | | | | |
| Silica | Part by | 65 | 65 | 65 | 65 |
| | mass | | | | |
| Silane coupling | Part by | 4.5 | 4.5 | 4.5 | 4.5 |
| agent | mass | | | | |
| Oil | Part by | 35.0 | 15.0 | 32.0 | 30.0 |
| | mass | | | | |
| Resin component-1 | Part by | 0.0 | 0.0 | 3.0 | 5.0 |
| | mass | | | | |
| Softener C (Wc) | (part by | (35.0) | (15.0) | (35.0) | (35.0) |
| | mass) | | | | |
| Resin | — | 0.00 | 0.00 | 0.09 | 0.14 |
| component/softener | | | | | |
| C | | | | | |
| Type of rubber composition | | UT | UT | UT | UT |
| for undertread | | Composition 2 | Composition 2 | Composition 2 | Composition 2 |
| Softener U (Wu) for | (part by | (10.0) | (10.0) | (10.0) | (10.0) |
| UT | mass) | | | | |
| Difference in | (part by | (25.0) | (5.0) | (25.0) | (25.0) |
| compounded amount | mass) | | | | |
| (Wc − Wu) | | | | | |
| Ratio of | (part by | (3.5) | (1.5) | (3.5) | (3.5) |
| compounded | mass) | | | | |
| amounts (Wc/Wu) | | | | | |
| Rubber hardness | — | 55 | 63 | 55 | 55 |
| Amount of softener | Index | 100 | 91 | 99 | 96 |
| migrating to UT | value | | | | |
| Performance on ice | Index | 100 | 86 | 100 | 100 |
| | value | | | | |
| | | | | | Comparative |
| | | Example 2 | Example 3 | Example 4 | Example 3 |
| NR | Part by | 55 | 55 | 55 | 55 |
| | mass | | | | |
| BR | Part by | 45 | 45 | 45 | 45 |
| | mass | | | | |
| Carbon black | Part by | 15 | 15 | 15 | 15 |
| | mass | | | | |
| Silica | Part by | 65 | 65 | 65 | 65 |
| | mass | | | | |
| Silane coupling | Part by | 4.5 | 4.5 | 4.5 | 4.5 |
| agent | mass | | | | |
| Oil | Part by | 20.0 | 30.0 | 20.0 | 3.0 |
| | mass | | | | |
| Resin component-1 | Part by | 15.0 | 5.0 | 15.0 | 32.0 |
| | mass | | | | |
| Softener C (Wc) | (part by | (35.0) | (35.0) | (35.0) | (35.0) |
| | mass) | | | | |
| Resin | — | 0.43 | 0.14 | 0.43 | 0.91 |
| component/softener | | | | | |
| C | | | | | |
| Type of rubber composition | | UT | UT | UT | UT |
| for undertread | | Composition 1 | Composition 3 | Composition 2 | Composition 2 |
| Softener U (Wu) for | (part by | (5.0) | (15.0) | (10.0) | (10.0) |
| UT | mass) | | | | |
| Difference in | (part by | (30.0) | (20.0) | (25.0) | (25.0) |
| compounded amount | mass) | | | | |
| (Wc − Wu) | | | | | |
| Ratio of | (part by | (7.0) | (2.3) | (3.5) | (3.5) |
| compounded | mass) | | | | |
| amounts (Wc/Wu) | | | | | |
| Rubber hardness | — | 55 | 55 | 56 | 56 |
| Amount of softener | Index | 95 | 98 | 94 | 91 |
| migrating to UT | value | | | | |
| Performance on ice | Index | 99 | 100 | 99 | 95 |
| | value | | | | |

TABLE 2

| | | Example 5 | Example 6 | Example 7 |
|---|---|---|---|---|
| NR | Part by | 55 | 55 | 55 |
| | mass | | | |
| BR | Part by | 45 | 45 | 45 |
| | mass | | | |
| Carbon black | Part by | 15 | 15 | 15 |
| | mass | | | |
| Silica | Part by | 65 | 65 | 65 |
| | mass | | | |
| Silane coupling agent | Part by | 4.5 | 4.5 | 4.5 |
| | mass | | | |
| Oil | Part by | 30.0 | 30.0 | 30.0 |
| | mass | | | |
| Resin component-1 | Part by | 30.0 | 30.0 | 30.0 |
| | mass | | | |
| Resin component-2 | Part by | | | |
| | mass | | | |
| Resin component-3 | Part by | | | |
| | mass | | | |
| Softener C (Wc) | (part by | (60.0) | (60.0) | (60.0) |
| | mass) | | | |
| Resin | — | 0.50 | 0.50 | 0.50 |
| component/softener C | | | | |
| Type of rubber composition for | | UT Composition | UT Composition | UT Composition |
| undertread | | 2 | 1 | 3 |
| Softener U (Wu) for UT | (part by | (10.0) | (5.0) | (15.0) |
| | mass) | | | |
| Difference in | (part by | (50.0) | (55.0) | (45.0) |
| compounded amount | mass) | | | |
| (Wc − Wu) | | | | |
| Ratio of compounded | (part by | (6.0) | (12.0) | (4.0) |
| amounts (Wc/Wu) | mass) | | | |
| Rubber hardness | — | 48 | 48 | 48 |
| Amount of softener | Index | 96 | 98 | 94 |
| migrating to UT | value | | | |
| Performance on ice | Index | 99 | 100 | 100 |
| | value | | | |
| | | Example 8 | Example 9 | Example 10 |
| NR | Part by | 55 | 55 | 55 |
| | mass | | | |
| BR | Part by | 45 | 45 | 45 |
| | mass | | | |
| Carbon black | Part by | 15 | 15 | 15 |
| | mass | | | |
| Silica | Part by | 65 | 65 | 65 |
| | mass | | | |
| Silane coupling agent | Part by | 4.5 | 4.5 | 4.5 |
| | mass | | | |
| Oil | Part by | 30.0 | 30.0 | 30.0 |
| | mass | | | |
| Resin component-1 | Part by | | 15.0 | |
| | mass | | | |
| Resin component-2 | Part by | 30.0 | 15.0 | |
| | mass | | | |
| Resin component-3 | Part by | | | 30.0 |
| | mass | | | |
| Softener C (Wc) | (part by | (60.0) | (60.0) | (60.0) |
| | mass) | | | |
| Resin | — | 0.50 | 0.50 | 0.50 |
| component/softener C | | | | |
| Type of rubber composition for | | UT Composition | UT Composition | UT Composition |
| undertread | | 2 | 2 | 2 |
| Softener U (Wu) for UT | (part by | (10.0) | (10.0) | (10.0) |
| | mass) | | | |
| Difference in | (part by | (50.0) | (50.0) | (50.0) |
| compounded amount | mass) | | | |
| (Wc − Wu) | | | | |
| Ratio of compounded | (part by | (6.0) | (6.0) | (6.0) |
| amounts (Wc/Wu) | mass) | | | |
| Rubber hardness | — | 54 | 52 | 51 |
| Amount of softener | Index | 96 | 94 | 98 |
| migrating to UT | value | | | |
| Performance on ice | Index | 100 | 100 | 100 |
| | value | | | |

TABLE 3

| | | Example 11 | Example 12 | Example 13 | Example 14 |
|---|---|---|---|---|---|
| NR | Part by | 65 | 47 | 40 | 55 |
| | mass | | | | |
| BR | Part by | 35 | 53 | 60 | 45 |
| | mass | | | | |
| Carbon black | Part by | 15 | 15 | 15 | 15 |
| | mass | | | | |
| Silica | Part by | 65 | 65 | 65 | 65 |
| | mass | | | | |
| Silane coupling | Part by | 4.5 | 4.5 | 4.5 | 4.5 |
| agent | mass | | | | |
| Oil | Part by | 30.0 | 30.0 | 30.0 | 35.0 |
| | mass | | | | |
| Resin component-1 | Part by | 5.0 | 5.0 | 5.0 | 10.0 |
| | mass | | | | |
| Resin component-4 | Part by | | | | |
| | mass | | | | |
| Softener C (Wc) | (part by | (35.0) | (35.0) | (35.0) | (45.0) |
| | mass) | | | | |
| Resin | — | 0.14 | 0.14 | 0.14 | 0.22 |
| component/softener | | | | | |
| C | | | | | |
| Type of rubber composition | | UT | UT | UT | UT |
| for undertread | | Composition 2 | Composition 2 | Composition 2 | Composition 2 |
| Softener U (Wu) for | (part by | (10.0) | (10.0) | (10.0) | (10.0) |
| UT | mass) | | | | |
| Difference in | (part by | (25.0) | (25.0) | (25.0) | (35.0) |
| compounded amount | mass) | | | | |
| (Wc − Wu) | | | | | |
| Ratio of | (part by | (3.5) | (3.5) | (3.5) | (4.5) |
| compounded | mass) | | | | |
| amounts (Wc/Wu) | | | | | |
| Rubber hardness | — | 55 | 54 | 52 | 55 |
| Amount of softener | Index | 98 | 95 | 98 | 92 |
| migrating to UT | value | | | | |
| Performance on ice | Index | 99 | 105 | 105 | 100 |
| | value | | | | |

| | | Comparative | Comparative | Comparative |
|---|---|---|---|---|
| | | Example 4 | Example 5 | Example 6 |
| NR | Part by | 55 | 90 | 55 |
| | mass | | | |
| BR | Part by | 45 | 10 | 45 |
| | mass | | | |
| Carbon black | Part by | 15 | 15 | 15 |
| | mass | | | |
| Silica | Part by | 65 | 60 | 65 |
| | mass | | | |
| Silane coupling agent | Part by | 4.5 | 4.5 | 4.5 |
| | mass | | | |
| Oil | Part by | 45.0 | 20.0 | 30.0 |
| | mass | | | |
| Resin component-1 | Part by | 30.0 | 15.0 | |
| | mass | | | |
| Resin component-4 | Part by | | | 30.0 |
| | mass | | | |
| Softener C (Wc) | (part by | (75.0) | (35.0) | (60.0) |
| | mass) | | | |
| Resin | — | 0.40 | 0.43 | 0.50 |
| component/softener C | | | | |
| Type of rubber composition for | | UT Composition | UT Composition | UT Composition |
| undertread | | 2 | 2 | 2 |
| Softener U (Wu) for UT | (part by | (10.0) | (10.0) | (10.0) |
| | mass) | | | |
| Difference in | (part by | (65.0) | (25.0) | (50.0) |
| compounded amount | mass) | | | |
| (Wc − Wu) | | | | |
| Ratio of compounded | (part by | (7.5) | (3.5) | (6.0) |
| amounts (Wc/Wu) | mass) | | | |
| Rubber hardness | — | 43 | 56 | 53 |
| Amount of softener | Index | 106 | 94 | 100 |
| migrating to UT | value | | | |
| Performance on ice | Index | 105 | 92 | 99 |
| | value | | | |

Types of raw materials used as indicated in Tables 1 to 3 are described below.
NR: natural rubber, TSR20
BR: polybutadiene, Nipol BR1220 (unmodified BR, available from ZEON CORPORATION)
Carbon black: Show Black N339, available from Cabot Japan K.K.
Silica: ZEOSIL 1165MR, CTAB adsorption specific surface area: 159 m²/g, available from Rhodia
Silane coupling agent: Si69 (bis(3-triethoxysilylpropyl) tetrasulfide, available from Evonik Degussa Corporation
Oil: Extract No. 4S, available from Showa Shell Sekiyu K.K.
Resin component-1: aromatic modified terpene resin, softening point: 125° C., YS Resin TO125, available from Yasuhara Chemical Co., Ltd.
Resin component-2: rosin ester, softening point: 95° C., super ester A100, available from Arakawa Chemical Industries, Ltd.
Resin component-3: aromatic modified terpene resin, Softening point: 105° C., YS Resin TO105, available from Yasuhara Chemical Co., Ltd.
Resin component-4: aromatic modified terpene resin, Softening point: 85° C., YS Resin TO85, available from Yasuhara Chemical Co., Ltd.

TABLE 4
Common composition of rubber composition for cap tread

| | | |
|---|---|---|
| Anti-aging agent | 3.0 | parts by mass |
| Wax | 2.0 | parts by mass |
| Stearic acid | 2.0 | parts by mass |
| Zinc oxide | 4.0 | parts by mass |
| Sulfur | 1.5 | parts by mass |
| Vulcanization accelerator-1 | 2.0 | parts by mass |
| Vulcanization accelerator-2 | 1.5 | parts by mass |

Types of raw materials used as indicated in Table 4 are described below.
Anti-aging agent: Santoflex 6PPD, available from Flexsys
Wax: SANNOC, available from Ouchi Shinko Chemical Industrial Co., Ltd.
Stearic acid: stearic acid bead, available from NOF Corporation
Zinc oxide: Zinc Oxide III, available from Seido Chemical Industry Co., Ltd.
Sulfur: MUCRON OT-20 (sulfur content: 80 mass %), available from SHIKOKU CHEMICALS CORPORATION
Vulcanization accelerator-1: NOCCELER CZ-G, available from Ouchi Shinko Chemical Industrial Co., Ltd.
Vulcanization accelerator-2: Soxinol D-G, available from Sumitomo Chemical Co., Ltd.

TABLE 5

| | | UT | UT | UT |
|---|---|---|---|---|
| Composition of rubber | | Compo- | Compo- | Compo- |
| composition for undertread | | sition 1 | sition 2 | sition 3 |
| NR | Part by mass | 55.0 | 55.0 | 55.0 |
| BR | Part by mass | 33.0 | 33.0 | 33.0 |
| SBR | Part by mass | 12.0 | 12.0 | 12.0 |
| Carbon black | Part by mass | 65.0 | 65.0 | 65.0 |
| Oil | Part by mass | 5.0 | 10.0 | 15.0 |
| Stearic acid | Part by mass | 1.0 | 1.0 | 1.0 |
| Zinc oxide | Parts by mass | 3.0 | 3.0 | 3.0 |
| Anti-aging agent | Part by mass | 2.5 | 2.5 | 2.5 |
| Sulfur | Part by mass | 3.5 | 3.5 | 3.5 |
| Vulcanization | Part by mass | 1.2 | 1.2 | 1.2 |
| accelerator-3 | | | | |

The types of raw materials used as indicated in Table 5 are described below.
NR: natural rubber, TSR20
BR: butadiene rubber, Nipol BR1220, available from ZEON CORPORATION
SBR: styrene-butadiene rubber, Nipol 1502, available from ZEON CORPORATION
Carbon black: Show Black N339, available from Cabot Japan K.K.
Oil: Extract No. 4S, available from Showa Shell Sekiyu K.K.
Stearic acid: stearic acid bead, available from NOF Corporation
Anti-aging agent: Santoflex 6PPD, available from Flexsys
Zinc oxide: Zinc Oxide III, available from Seido Chemical Industry Co., Ltd.
Sulfur: MUCRON OT-20 (sulfur content: 80 mass %), available from SHIKOKU CHEMICALS CORPORATION
Vulcanization accelerator-3: SANTOCURE NS, available from MONSANT COMPANY

As clear from Tables 1 to 3, the pneumatic tires of Examples 1 to 14 have a rubber hardness of 60 or less. Therefore, migration of the softener from the cap tread to the undertread is reduced as much as possible, a change in rubber curing over time can be suppressed, and superior performance on ice can be maintained beyond levels in the related arts.

In the pneumatic tire of Comparative Example 1, the amount of the plasticizer component (oil) was reduced as compared with that in the cap tread of the pneumatic tire of Standard Example. The resin component was not blended, and thus the rubber hardness was greater than 60 and performance on ice was reduced.

In the pneumatic tire of Comparative Example 2, the compounded amount of the resin component is less than 5 parts by mass, and the mass ratio of the resin component in the softener C is less than 0.1. Thus, an effect of reducing the amount of the softener that migrates from the cap tread to the undertread cannot be sufficiently obtained.

In the pneumatic tire of Comparative Example 3, the compounded amount of the resin component is greater than 30 parts by mass, and the mass ratio of the resin component in the softener C is greater than 0.5. Thus, performance on ice is deteriorated.

In the pneumatic tire of Comparative Example 4, the compounded amount Wc of the softener C including the resin component and the plasticizer component is greater than 70 parts by mass, and the difference (Wc−Wu) between the compounded amount of the softener C and the compounded amount of the softener U is greater than 60 parts by mass. Thus, the amount of the softener that migrates from the cap tread to the undertread is increased.

In the pneumatic tire of Comparative Example 5, the compounded amount of polybutadiene is less than 30 mass %, and thus performance on ice is deteriorated.

In the pneumatic tire of Comparative Example 6, the softening point of the resin component-4 is lower than 90° C., and thus an effect of reducing the amount of the softener that migrates from the cap tread to the undertread is not obtained.

1. A pneumatic tire comprising:
a tread portion having a cap tread disposed outward in a tire radial direction and an undertread disposed inward in the tire radial direction,
the undertread being made of a rubber component for an undertread obtained by blending Wu parts by mass, provided that Wu means a real number of 0 or greater, of a softener U including a plasticizer component with 100 parts by mass of a rubber component,
the cap tread being made of a rubber component for a cap tread that is obtained by blending 30 parts by mass or greater of silica and Wc parts by mass, provided that Wc means a real number of from 20 to 70, of a softener C including from 5 to 30 parts by mass of at least one resin component having a softening point of from 90° C. to 150° C. and a plasticizer component with 100 parts by mass of a diene rubber containing 30 mass % or greater of polybutadiene,
the rubber component for a cap tread having a mass ratio of the resin component in the softener C of from 0.1 to 0.5 and a rubber hardness at 20° C. with type A in accordance with JIS K6253 of 60 or less,
a difference (Wc−Wu) in compounded amount between the softener C and the softener U being from 20 parts by mass to 60 parts by mass.

2. The pneumatic tire according to claim 1, wherein the ratio (Wc/Wu) of the compounded amount of the softener C to that of the softener U is from 2.0 to 10.0.

3. The pneumatic tire according to claim 1, wherein the resin component is a terpene resin.

4. The pneumatic tire according to claim 1, wherein the resin component is an aromatic modified terpene resin.

5. The pneumatic tire according to claim 2, wherein the resin component is a terpene resin.

6. The pneumatic tire according to claim 5, wherein the resin component is an aromatic modified terpene resin.
